(19) United States
(12) Patent Application Publication
(10) Pub. No.: US 2017/0148104 A1
(43) Pub. Date: May 25, 2017

(54) METHOD FOR DETERMINING EXCEPTIONS IN A RISK-MITIGATION SCHEDULE

(71) Applicant: MasterCard International Incorporated, Purchase, NY (US)

(72) Inventors: Shweta Khattar, Dwarka (IN); Amit GUPTA, New Delhi (IN); Nidhi Taneja, New Delhi (IN)

(21) Appl. No.: 15/346,460

(22) Filed: Nov. 8, 2016

(30) Foreign Application Priority Data
Nov. 19, 2015 (SG) 10201509531T

(51) Int. Cl. G06Q 40/08

(52) U.S. Cl. CPC G06Q 40/08

(57) ABSTRACT

A method for determining exceptions in a risk-mitigation schedule of an at-risk entity is provided. The method includes determining a plurality of parameters defining the at-risk entity, each parameter having a value and a value-type. The method also includes identifying a constraint for each parameter, and using a schedule generator to generate an entity profile using the constraints, determine, from at least one precedent profile, a best fit precedent profile based on a minimum deviation of the best fit precedent profile from the entity profile, produce a precedent risk-mitigation schedule for the best fit precedent profile, and determine at least one disparity between the precedent risk-mitigation schedule and the risk-mitigation schedule of the at-risk entity. The method further includes displaying an exceptions schedule to the at-risk entity that includes the at least one disparity.

### CROSS REFERENCE TO RELATED APPLICATIONS

This application claims the benefit of Singapore Patent Application No. 10201509531T filed Nov. 19, 2015, which is hereby incorporated by reference in its entirety.

### BACKGROUND

The present disclosure relates to risk-mitigation schedules, such as insurance policies. Such schedules endeavor to reduce the risk to which an at-risk entity, such as a business or person, is exposed. That risk may be physical or financial risk.

The present disclosure relates particularly to methods for determining whether an at-risk entity has an appropriate risk-mitigation schedule when compared with the risk-mitigation schedules of similar entities.

Many at-risk entities, such as people or businesses, experience injury or loss as a result of contingencies. By their very nature, contingencies cannot be predicted. However, many organizations compensate at-risk entities upon occurrence of a contingency. Such organizations use a schedule (i.e. a risk-mitigation schedule) to define the types of contingencies for which an at-risk entity will receive compensation, and the amount of that compensation.

Since contingencies are unplanned or unpredictable events, it can be difficult for an at-risk entity to determine whether it has acquired an appropriate risk-mitigation schedule. Moreover, since the organization offering the risk-mitigation schedule is not comparable to the at-risk entity (i.e. the individual or business) seeking that schedule, it can be difficult for the organization to determine the types of contingencies to which the at-risk entity is exposed.

It would, therefore, desirable to provide a system and method for identifying the types of contingencies for which an at-risk entity should seek compensation, and for organizations to determine the types of contingencies for which they typically provide compensation.

### BRIEF DESCRIPTION

The present disclosure provides a method for determining exceptions in a risk-mitigation schedule of an at-risk entity, the method includes determining a plurality of parameters defining the at-risk entity, each parameter having a value and a value-type, wherein the value-type and value of at least one parameter from the plurality of parameters is derived from financial transaction data of the at-risk entity, identifying, using a processor, a constraint for each parameter, each constraint being either a range including the value of the respective parameter, or a Boolean variable representing the value of the respective parameter, using a schedule generator to generate an entity profile using the constraints, determine, from at least one precedent profile stored in a memory device, a best fit precedent profile based on a minimum deviation of the best fit precedent profile from the entity profile, each of the at least one precedent profiles being generated based on a plurality of parameters defining at least one further entity that is different from the at-risk entity, produce a precedent risk-mitigation schedule for the best fit precedent profile, and determine at least one disparity between the precedent risk-mitigation schedule and the risk-mitigation schedule of the at-risk entity, and displaying, on a display, an exceptions schedule to the at-risk entity, the exceptions schedule including the at least one disparity.

The present disclosure further provides a computer system for determining exceptions in a risk-mitigation schedule of an at-risk entity, the method includes a memory device for storing data, a display, and a processor coupled to the memory device and being configured to determine a plurality of parameters defining the at-risk entity, each parameter having a value and a value-type, wherein the value-type and value of at least one parameter from the plurality of parameters is derived from financial transaction data of the at-risk entity, and identify, using a processor, a constraint for each parameter, each constraint being either a range including the value of the respective parameter, or a Boolean variable representing the value of the respective parameter, and a schedule generator coupled to the processor and configured to generate an entity profile using the constraints, determine, from at least one precedent profile stored in a memory device, a best fit precedent profile based on a minimum deviation of the best fit precedent profile from the entity profile, each of the at least one precedent profiles being generated based on a plurality of parameters defining at least one further entity that is different from the at-risk entity, produce a precedent risk-mitigation schedule for the best fit precedent profile, and determine at least one disparity between the precedent risk-mitigation schedule and the risk-mitigation schedule of the at-risk entity, and the processor being further configured to displaying, on the display, an exceptions schedule to the at-risk entity, the exceptions schedule including the at least one disparity.

The present disclosure also provides a computer program embodied on a non-transitory computer readable medium for generating a precedent risk-mitigation schedule for a customer segment, the program at least one code segment executable by a computer to instruct the computer to determine a plurality of parameters defining the at-risk entity, each parameter having a value and a value-type, wherein the value-type and value of at least one parameter from the plurality of parameters is derived from financial transaction data of the at-risk entity, identify, using a processor, a constraint for each parameter, each constraint being either a range including the value of the respective parameter, or a Boolean variable representing the value of the respective parameter, generate an entity profile using the constraints, determine, from at least one precedent profile stored in a memory device, a best fit precedent profile based on a minimum deviation of the best fit precedent profile from the entity profile, each of the at least one precedent profiles being generated based on a plurality of parameters defining at least one further entity that is different from the at-risk entity, produce a precedent risk-mitigation schedule for the best fit precedent profile, determine at least one disparity between the precedent risk-mitigation schedule and the risk-mitigation schedule of the at-risk entity, and the processor being further configured to displaying, on the display, an exceptions schedule to the at-risk entity, the exceptions schedule including the at least one disparity.

Unless context dictates otherwise, the following terms will have the meaning given here:

The term “entity” includes an individual, business, collection of individuals or businesses or any other party that may experience a contingency. The entity may also be a virtual or hypothetical entity such that the methods described herein can be used for speculative purposes and modelling risk-mitigation schedules.

The term “contingency” refers to any unexpected event that may cause financial or physical loss to the entity experiencing the contingency. For example, where the entity is an individual, the contingency may be a physical disablement (partial or full), destruction, theft, or loss of property.

The term “at-risk”, as used in relation to an entity as described above, refers to any entity which may be subjected to a contingency or negatively-impacting event in which financial or physical loss is experienced.

The term “risk-mitigation schedule provider” may be any party, or their representative, that provides compensation to an at-risk entity in the event that the entity experiences a contingency.

The term “exception”, when used in relation to a risk-mitigation schedule, refers to an absence or difference between the risk-mitigation schedule of the entity in question and the precedent risk-mitigation schedule determined using the methods taught herein.

The term “risk-mitigation schedule” refers to a schedule, report or similar that defines the contingencies that are compensable and the conditions, if any, under which compensation will or will not be given. A risk-mitigation schedule may also set out other information, such as any limits applied to the compensation.

A “risk-mitigation provider” is any party that provides compensation in line with a risk-mitigation schedule, in the event of a contingency, or the agent of such a party.

### BRIEF DESCRIPTION OF THE DRAWINGS

Some embodiments of the methods taught herein will now be described, by way of non-limiting example only, with reference to the accompanying drawings in which:

FIG. 1 shows a method for determining exceptions in a risk-mitigation schedule of an at-risk entity, in accordance with present teachings, the method being commenced by an at-risk entity or their representative.

FIG. 2 shows a method for determining exceptions in a risk-mitigation schedule of an at-risk entity, in accordance with present teachings, the method being commenced by a risk-mitigation schedule provider or their representative.

FIG. 3 shows a schematic embodiment of a system for determining exceptions in a risk-mitigation schedule of an at-risk entity.

FIG. 4 shows an exemplary computing device suitable for executing the method for determining exceptions in a risk-mitigation schedule of an at-risk entity.

FIG. 5 is a schematic data flow diagram of a method in accordance with present teachings.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic, or optical signals capable of being stored, transferred, combined, compared, and otherwise manipulated.

Unless specifically stated otherwise, and as apparent from the following, it will be appreciated that throughout the present specification, discussions utilizing terms, such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission, or display devices.

The present specification also discloses apparatus for performing the operations of the methods. Such apparatus may be specially constructed for the required purposes, or may include a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program when loaded and executed on such a computer effectively results in an apparatus that implements the steps of the exemplary method.

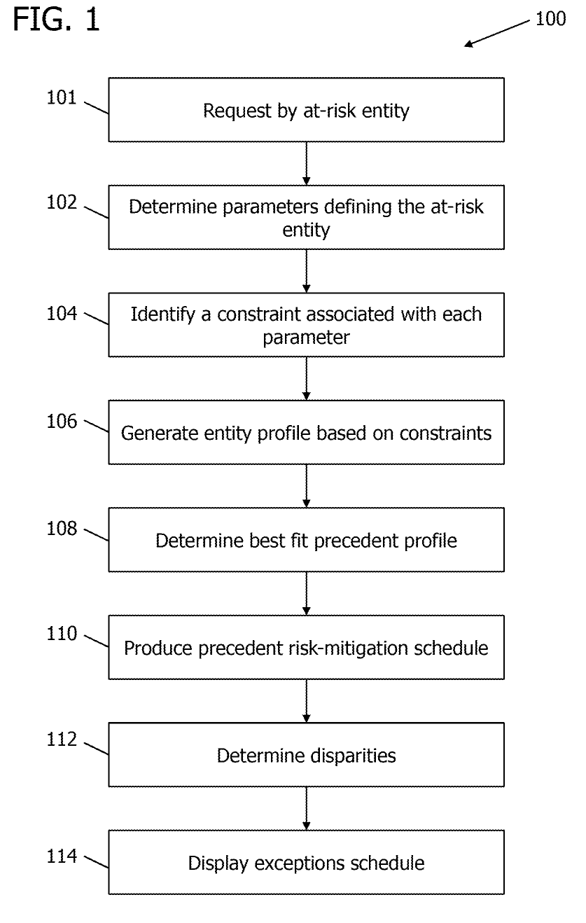

FIG. 1 illustrates a method 100 for determining exceptions in a risk-mitigation schedule of an at-risk entity. Broadly speaking, the method includes the steps of:

Step 101: requesting a risk-mitigation or exceptions schedule;

Step 102: determining a plurality of parameters defining the at-risk entity;

Step 104: identifying a constraint for each parameter;

Step 106: generating an entity profile;

Step 108: determining a best fit precedent profile;

Step 110: producing a precedent risk-mitigation schedule;

Step 112: determining the presence of a disparity or disparities (e.g. a difference or differences) between the precedent risk-mitigation schedule and the risk-mitigation schedule of the at-risk entity; and

Step 114: displaying an exceptions schedule to the at-risk entity.

At step 101, an at-risk entity, such as an individual or business, requests an exceptions schedule. The exceptions schedule sets out the particular contingencies for which the current risk-mitigation schedule of the at-risk entity has no, or insufficient, compensation. The exceptions schedule may also set out where the at-risk entity may have planned on too much compensation. For example, where the risk-mitigation schedule is an insurance policy, the exceptions schedule may set out where the at-risk entity has no insurance but should, where the at-risk entity is underinsured, or where the at-risk entity is over-insured.

At step 102, parameters are determined. The parameters define the at-risk entity. In other words, the parameters are each indicative of a property or characteristic of the at-risk entity.

Each parameter has a value and a value-type. The value-type infers a property or characteristic of the entity that may affect the likelihood of that entity experiencing a contingency (e.g. stroke, injury, loss, or theft), and the value is the value of that property of characteristic. Moreover, the value-type may depend on the nature of the entity. For example, where the entity is an individual, a value-type may be the income of the individual, whether or not the individual is a smoker or the average monthly spend of the individual. With regard to the average monthly spend, the value-type may be even more granular, such as the average monthly spend on medical services, a particular type of medical service (e.g. dentistry, ophthalmology, physiotherapy, or chiropractic services), cigarettes, food, particular food types (e.g. categories of food, such as fat foods, vegetables, or meats), alcohol, travel, and so forth, and the value in each case would be a currency (e.g. $). Similarly, where the value-type is an individual's age, the value would be, for example, 34 years.

For a business, the value-types may be monthly revenue, type of industry (e.g. mining, medical, or food & beverage), number of employees, and so forth and, in each of these example cases, the value would be numerical. Thus, the parameters may differ depending on the nature of the entity.

Lifestyle and discretionary decisions can influence the behavior of the entity, and their appetite for risk, particularly where the entity is an individual. Lifestyle and discretionary decisions are, therefore, key contributors to the likelihood that the entity will experience a contingency and, thus, increase the likelihood that compensation for such a contingency will need to be paid. So as to identify some of the lifestyle and discretionary decisions of the at-risk entity, the value-type and value of at least one parameter can be derived from financial transaction data of the at-risk entity. Such financial transaction data may include one or more of the monthly spend items stated above, or any other piece of financial data.

Data from which parameters are determined can be inputted by a user (e.g. into an app interface, a web portal, or other interface). Such data may also be received from other sources. For example, data may be received from an issuer bank (e.g. Citibank®), such as the issuer of a credit card belonging to the at-risk entity, an insurer that may or may not already hold an insurance policy for the at-risk entity, or a research business.

Where data is received from an issuer bank, it will be called “issuer-held” data. Issuer-held data can be useful in defining parameters that rely on financial data (e.g. monthly income, monthly spend, and so forth). Issuer-held data may also enable the demographic of the at-risk entity to be determined. Issuer-held data can enable the creation (e.g. determination) of parameters based on the types of products or services procured by the at-risk entity. In this sense, “issuer-held data” is taken to include any data held by the issuer bank, such as the age, gender, income and residential address of an at-risk entity.

Where data is received from a payment scheme (e.g. a credit card scheme), it will be referred to as “payment scheme data”. Payment scheme data is collected from transaction level data and information about payment vehicles used to effect transaction from which that transaction level data is collected, before passing some of that data to the issuer.

Data received from an insurer will be called “insurer data”. Insurer data can also include a significant amount of information about the at-risk entity, such as their age, smoker status (though this can also often be derived from issuer-held data by identifying purchases of cigarettes), residential address, and any previous or existing risk-mitigation schedules (e.g. insurance policies). Thus, the insurer data can include the risk-mitigation schedule of the at-risk entity or a parameter of the at-risk entity.

The at-risk entity may also be associated with a customer segment. Customer segments may be defined by parameters (e.g. age, gender, income band, residential address) and, or in the alternative, by spending behavior, such as the average spend per account or month, the industry in which the spend occurs (e.g. retail), the nature of the spend (e.g. discretionary or essential), or the mode of spending (e.g. online purchase, in-store purchase, payment by cash, or payment with credit).

Once an at-risk entity is associated with a customer segment, certain characteristics of the at-risk entity can be inferred on the basis that such characteristics are, at least in general, common to other entities in the same customer segment. In other words, where an individual is a 40 year old male living in an affluent suburb, one or more parameters may be able to be determined on the basis that those one or more parameters apply, in general, to 40 year old males living in affluent suburbs.

Thus, the method may include associating the at-risk entity with a customer segment according to one or more parameters of the at-risk entity (e.g. age or gender). Once a customer segment of the at-risk entity has been identified, customer segment data can be received or obtained from a research business. That customer segment data may relate to products and services commonly acquired by the customer segment, or any other relevant information, from which one or more further parameters of the at-risk entity can be determined.

At step 104, a constraint is identified for each parameter. Each constraint is either a range including the value of the respective parameter, or a Boolean variable representing the value of the respective parameter. To illustrate, where the entity is an individual and the value-type of a parameter is the monthly income of the individual, the value may be, for example, $5,000 per month. The corresponding constraint may then be a range of monthly income, including the value in question (e.g. $5,000 to $5,999). A Boolean variable, instead, defines something that is either correct or incorrect. For example, where the entity is an individual and the value-type is the individual's smoker status, the value is True or False—in other words, the individual is either a smoker or is not a smoker.

Some parameters may be related. For example, a Boolean variable representing smoker status may be related to a range constraint indicating an individual's average monthly spend on cigarettes.

Each parameter may be weighted. The weighting may be applied according to the value-type and whether the value-type represents a property or characteristic that is more or less likely to influence the occurrence of a contingency. For example, where the entity is an individual, the individual's monthly spend at fast food restaurants may be deemed indicative of that individual's health and, thus, effect the likelihood (e.g. a statistical likelihood) the individual will experience health problems. Thus, emphasis can be given to those parameters that result in a greater likelihood of a contingency arising than other parameters. Similarly, those parameters that are less likely to contribute to the occurrence of contingencies can be given a lower weighting and are, thus, de-emphasized.

Step 106 involves the generation of an entity profile using the constraints. The entity profile is, in effect, a data structure or record of the constraints. The entity profile may be specific to the entity at a particular point in time, and be compared to an entity profile generated for the same entity at a later point in time, thus, enabling the entity to determine how its risk-mitigation schedule should change over time. For example, where the entity is again an individual, older individuals are more likely to experience hospitalization than younger individuals. Therefore, the likelihood of a hospitalization type of contingency occurring generally increases with age. Similarly, an individual between 18 and 25 years of age is more likely to have a car accident (i.e. an injurious contingency, or damage to property) than an individual of the age of 40.

Step 108 relates to the mapping of an entity profile to one or more other entity profiles that have been previously prepared for particular entities. The previously prepared entity profiles are referred to as precedent profiles since the previously prepared entity profiles are used as a precedent for later determining whether or not there are exceptions in the risk-mitigation profile of the entity in question. In this context, a risk-mitigation schedule may be an insurance schedule, insurance policy, or similar.

From step 108, a best fit precedent profile is identified. That best fit profile may be one of many profiles stored in a memory device. Alternatively, that best fit profile may be formed from multiple different profiles stored in the memory device. In either case, similar to the entity profile of the entity in question (i.e. the “at-risk” entity), each of the precedent profiles is generated based on a plurality of parameters defining at least one further entity that is different from the entity in question.

The best fit precedent profile is identified based on a minimum deviation of the best fit precedent profile from the entity profile. The minimum deviation may be determined by comparing a constraint, or multiple constraints, common to a number of precedent profiles with a corresponding one or more constraints used to generate the entity profile. A “corresponding constraint” will, in general, be the same type of constraint, such as income, age, or gender. In other words, when comparing one entity profile to another, the age constraints will be compared such that the closer the age of the entities to whom the profiles relate, the lower the deviation between the profiles, and the gender and income constraints may be similarly compared.

Determining a minimum deviation may include weighting the constraints so that the minimum deviation emphasizes different properties or characteristics of the at-risk entity when compared with other properties or characteristics. For example, even where the profiles of two entities are relatively similar, if the at-risk entity has a smoker status of “non-smoker”, only those precedent profiles showing the same status may be used when identifying a best fit precedent profile. In this sense, a single parameter, such as the smoker-status parameter, can have a significant influence on which precedent entity profiles will be considered when identifying a best fit profile, and, thus, which profiles may be given a high weighting. Some parameters, such as the smoker status, may make the best fit determination a conditional determination. For example, a precedent profile can only be a best fit precedent profile if it satisfies the condition that the smoker status is the same as that of the entity profile. Conversely, where one parameter for the at-risk entity is its monthly income or spend on entertainment, that parameter may be given a very low weighting since it is unlikely to effect the probably that the at-risk entity will experience a contingency.

Once the best fit entity profile has been identified, it can be used to produce a precedent risk-mitigation schedule per step 110. Where the best fit entity profile is the entity profile of a single entity (i.e. where the at-risk entity is an individual, the best fit precedent profile may have been previously generated for a very similar individual), then the precedent risk-mitigation schedule may be the risk-mitigation schedule for that single entity. Conversely, where the best fit precedent profile is composed from the entity profiles of more than one entity, the precedent risk-mitigation schedule may be the average of the risk-mitigation schedules of those entities. Again, that average may be weighted according to the similarity of each individual entity, and their corresponding profile, to the at-risk entity and its profile. For example, the risk-mitigation schedule relating to a precedent profile that is closer to the best fit precedent profile may be given a higher weighting than the risk-mitigation schedule of a precedent profile that is further from the best fit precedent profile. Alternatively, one or more of the constraints may be weighted and the greater the deviation in that constraint, the lower the weighting. In other words, the weighting is inversely applied relative to the deviation in a constraint. To illustrate, if a constraint in the profile of the at-risk entity is an age range of age 30 to 34, meaning the entity is between 30 and 34 years of age, then the deviation in the corresponding age ranges for a first precedent profile (e.g. with an age range of 60 to 64) will result in that profile receiving a lower weighting than a second precedent profile (e.g. with an age range of 40 to 44).

The creation of a precedent risk-mitigation schedule enables the at-risk entity to determine whether their risk-mitigation schedule fulfils the norms for risk-mitigation schedules of similar entities. Since the precedent risk-mitigation schedule is based on the risk-mitigation schedule or schedules of one or more similar entities, there may already be an adjustment in the precedent risk-mitigation schedule for contingencies previously experienced by other similar entities. For example, where a similar entity experienced damage to property resulting from fire (i.e. a contingency), the at-risk entity may adjust its risk-mitigation schedule to account for future loss resulting from fire, or may increase the amount of compensation payable in the event of a fire. Thus, the precedent risk-mitigation schedule would be influenced by the introduction or increase of compensation relating to damage to property resulting from fire.

After the precedent risk-mitigation schedule has been developed, it can be compared against the risk-mitigation schedule of the at-risk entity to determine whether there is a disparity or multiple disparities, per step 112. In other words, the risk-mitigation schedule of the at-risk entity is compared against the precedent risk-mitigation schedule to determine if there are any differences. These disparities or differences suggest whether or not the at-risk entity has, or has sufficient, compensation specified for particular types of contingency.

Once the disparities have been identified, they are consolidated into an exceptions report or exceptions schedule. The exceptions report or exceptions schedule includes the disparity or disparities identified under step 112. The exceptions report or exceptions schedule may list the disparities or may present them in any other desired manner. The at-risk entity is then presented the exceptions schedule on a display, per step 114. Thus, the at-risk entity can determine whether there are sufficient differences (i.e. disparities), and the nature of those differences, to warrant an adjustment of their existing risk-mitigation schedule, or establishment of a new schedule where the at-risk entity has none in place prior to performance of the present method. Where the at-risk entity has not previously arranged for compensation in the event of contingencies (i.e. has no risk-mitigation schedule, which is equated to an empty (or null) schedule), the exceptions schedule will be substantially the same as the precedent risk-mitigation schedule.

The risk-mitigation schedule is supplied by, or in accordance with the requirements of, a risk-mitigation schedule provider. Such a provider may be an insurance company or insurer. The risk-mitigation schedule may also be provided by an insurance broker or other agent that acts as a proxy or representative of an insurer.

The risk-mitigation schedule may be accessible through a mobile app or online portal. Exceptions schedules can then be requested through an interface that interacts with the app or portal. In this manner, performance of the method described with reference to FIG. 1 may be requested by the at-risk entity or their representative, or may alternatively be requested by a risk-mitigation schedule provider in order to assess the position of a particular at-risk entity.

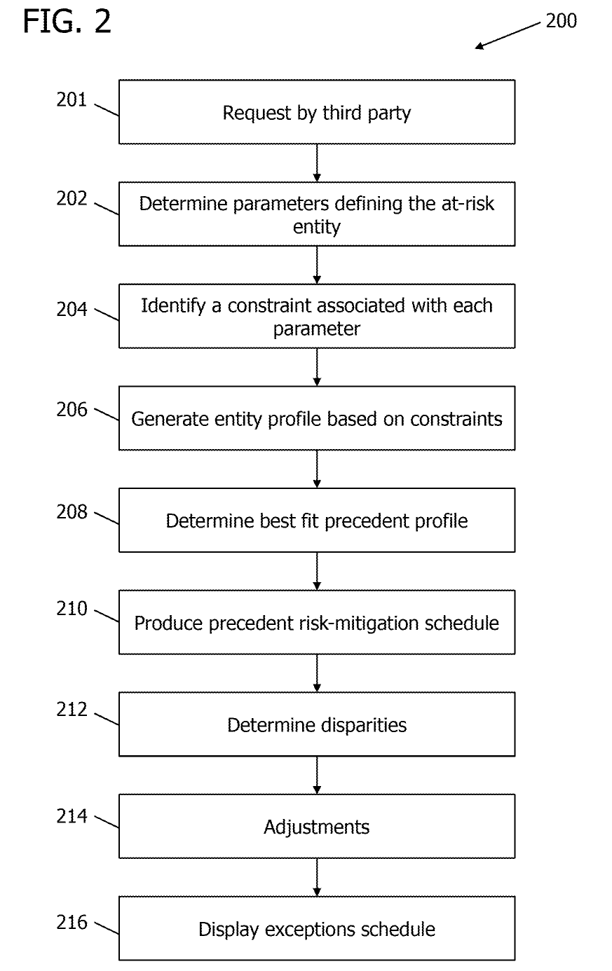

While the method described in relation to FIG. 1 applies where the at-risk entity requests the exceptions schedule, the exceptions schedule may be similarly requested by a representative of the at-risk entity, a risk-mitigation schedule provider (e.g. an insurer), or a representative of the risk-mitigation schedule provider (e.g. an insurance broker). Such a method is shown in FIG. 2, in which:

Step 201: involves a third party request for a risk-mitigation or exceptions schedule;

Step 202: determining a plurality of parameters defining the at-risk entity;

Step 204: identifying a constraint for each parameter;

Step 206: generating an entity profile;

Step 208: determining a best fit precedent profile;

Step 210: producing a precedent risk-mitigation schedule;

Step 212: determining the presence of a disparity or disparities (e.g. a difference or differences) between the precedent risk-mitigation schedule and the risk-mitigation schedule of the at-risk entity;

Step 214: adjusting the disparities; and

Step 216: displaying an exceptions schedule to the at-risk entity.

The main difference between the method of FIG. 1 and that of FIG. 2 is that the third party may apply adjustments at step 214. Adjustments may be made for any reason, including offering promotions or upgrades to insurance, applying discounts, adjusting for singular circumstances, and so forth. Singular circumstances may include, for example, where the at-risk entity is an individual and the disparities show no flood coverage, whereas the precedent profiles generally included such coverage. While the exceptions schedule would normally suggest that the individual considers flood coverage, where the individual lives on a flood plain, an insurer may not wish to provide flood protection and, thus, wish to remove an offering of such protection from the exceptions schedule.

The remaining steps in FIG. 2 are similar to those in FIG. 1.

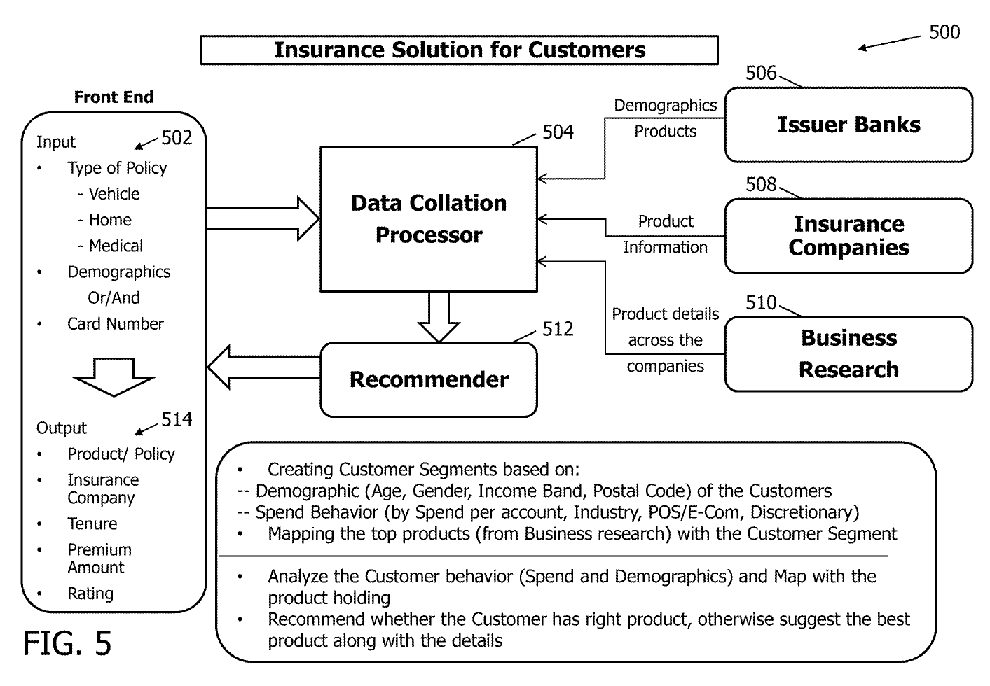

With reference to FIG. 5, a schematic representation of the method is shown, in terms of inputs, outputs, and interactions. From a user perspective, a request for a risk-mitigation schedule is made through the input module 502. The request includes an input of at least some parameters of the at-risk entity. That request is sent to a data collation processor 504 that collects data from issuer banks 506, such as data relating to demographics and products, insurance companies 508, such as insurance product information or previous risk-mitigation schedules of the at-risk entity, and data from research businesses 510, such as product details. The processor 504 identifies any further parameters, associates the parameters with constraints, and sends those constraints to the schedule generator or recommender engine 512. The recommender engine 512 processes the constraints and produces an exceptions schedule. The exceptions schedule is sent to the output module 514, which may be the same as the input module 502.

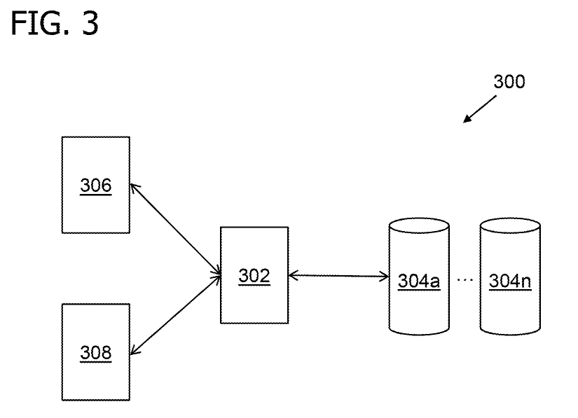

FIG. 3 shows an illustrative schematic of a network-based system 300 for determining exceptions in a risk-mitigation schedule of an at-risk entity. The system 300 includes a computer 302, one or more databases 304a . . . 304n, a user input module 306, and a user output module 308. Each of the one or more databases 304a . . . 304n is communicatively coupled with the computer 302. The user input module 306 and a user output module 308 may be separate and distinct modules communicatively coupled with the computer 302. For example, a user may be the at-risk entity, a risk-mitigation schedule provider, or another third party. Whoever requests the risk-mitigation schedule to be performed will do so through the user input module 306. Where the risk-mitigation schedule provider requests the risk-mitigation schedule on behalf of a particular at-risk entity, the at-risk entity may receive the exceptions schedule through the user output module 308. Thus, the user input module 306 and user output module 308 are different.

Alternatively, the user input module 306 and a user output module 308 may be integrated within a single device. For example, where the at-risk entity requests the risk-mitigation schedule, the user input module 306 may be the same as the user output module 308. That device may be a mobile electronic device (e.g. a mobile phone, a tablet computer, etc.). The mobile electronic device may have appropriate communication modules for wireless communication with the computer 302 via existing communication protocols.

The computer 302 may include at least one processor, a schedule generator, and at least one memory including computer program code, the at least one memory and the computer program code configured to, with at least one processor, cause the computer at least to (A) determine a plurality of parameters defining the at-risk entity, each parameter having a value and a value-type, wherein the value-type and value of at least one parameter from the plurality of parameters is derived from financial transaction data of the at-risk entity, (B) identify, using the processor, a constraint for each parameter, each constraint being either a range including the value of the respective parameter, or a Boolean variable representing the value of the respective parameter, use the schedule generator to (C(i)) generate an entity profile using the constraints, (C(ii)) determine, from at least one precedent profile stored in a memory device, a best fit precedent profile based on a minimum deviation of the best fit precedent profile from the entity profile, each of the at least one precedent profiles being generated based on a plurality of parameters defining at least one further entity that is different from the at-risk entity, (C(iii)) produce a precedent risk-mitigation schedule for the best fit precedent profile, and (C(iv)) determine at least one disparity between the precedent risk-mitigation schedule and the risk-mitigation schedule of the at-risk entity, and (D) display, on a display, an exceptions schedule to the at-risk entity, the exceptions schedule including the at least one disparity.

In an implementation, the computer 302 may be further caused to determine the plurality of parameters by (A(i)) receiving payment scheme data from a payment scheme (e.g. a credit card scheme) and/or (A(ii)) receiving issuer-held data from an issuer bank from which at least one of the plurality of parameters can be determined—this may include receiving issuer-held data regarding a demographic of the at-risk entity, or receiving data regarding products or services procured by the at-risk entity—(A(iii)) receiving insurer data from an insurer from which at least one of the plurality of parameters can be determined—this may include receiving one or both of the risk-mitigation schedule of the at-risk entity and at least one parameter of the at-risk entity—(G) associate the at-risk entity with a customer segment according to at least one parameter from the plurality of parameters, the customer segment defining characteristics typical of at-risk entities with a comparable value for said at least one parameter, (H) receive customer segment data from a research business from which at least one of the plurality of parameters can be determined, the data relating to products and services commonly acquired by the customer segment, determine a best fit precedent profile based on a minimum deviation from the entity profile by (C(ii(i))) comparing one or more constraints common to each precedent profile with a corresponding one or more constraints used to generate the entity profile, and (C(ii(ii))) weight the one or more constraints so that a deviation in one of two said constraints, between a precedent profile and the entity profile, has a greater influence on a deviation of the precedent profile from the entity profile than the other of the two constraints produce a precedent risk-mitigation schedule (C(iii(i))), when the best fit precedent profile is based on a plurality of parameters defining a single further entity, by producing a precedent risk-mitigation schedule that includes obtaining a risk-mitigation schedule for the further entity and using the risk-mitigation schedule for the further entity as the precedent risk-mitigation schedule, or (C(iii(ii))), when the best fit precedent profile is based on a plurality of parameters defining two or more further entities, by producing a precedent risk-mitigation schedule that includes obtaining a risk-mitigation schedule for each further entity and averaging the risk-mitigation schedules for those entities, where averaging the risk-mitigation schedules of the further entities can include weighting at least one constraint and applying a corresponding weighting to the risk-mitigation schedules for each entity based on an inverse of a deviation of a corresponding constraint of an entity profile for each further entity from each weighted constraint, and determine at least one disparity between the precedent risk-mitigation schedule and the risk-mitigation schedule of the at-risk entity by (C(iv(i))) identifying at least one difference between a constraint of the precedent risk-mitigation schedule and a corresponding constraint of the risk-mitigation schedule of the at-risk entity.

The various types of data, e.g. issuer-held data, such as electronic payment transaction data, obtained from the issuer bank, the insurer data obtained from an insurer, and the customer segment data obtained from a research business, can be stored on a single database (e.g. 304a), or stored in multiple databases (e.g. issuer-held data is stored on database 304a, insurer data is stored on database 304b, etc.). The databases 304a . . . 304n may be realized using cloud computing storage modules and/or dedicated servers communicatively coupled with the computer 302.

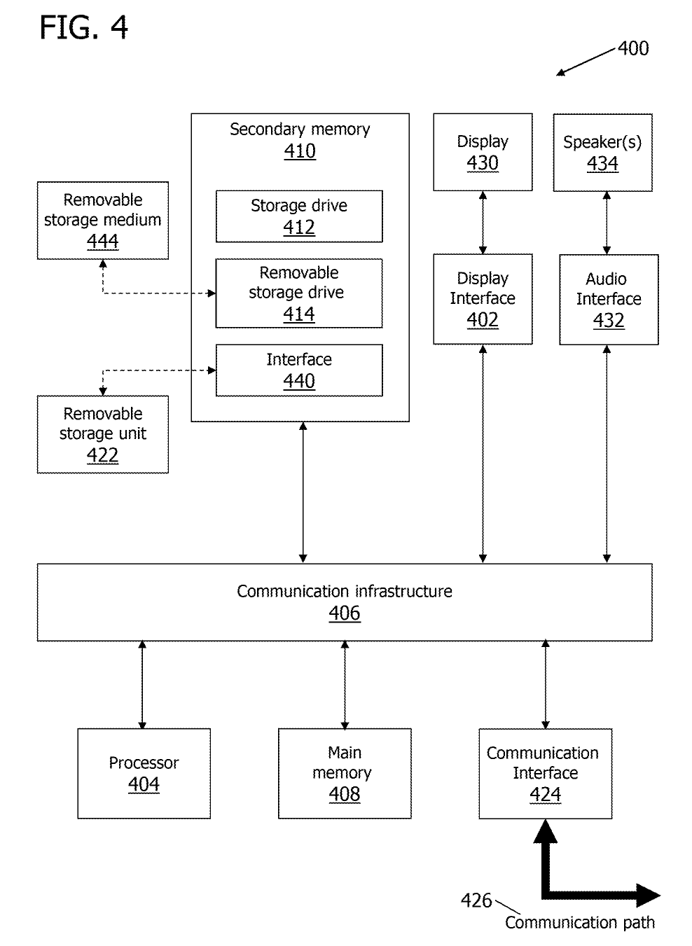

FIG. 4 depicts an exemplary computer/computing device 400, hereinafter interchangeably referred to as a computer system 400, where one or more such computing devices 400 may be used to facilitate execution of the above-described method for determining exceptions in a risk-mitigation schedule of an at-risk entity. In addition, one or more components of the computer system 400 may be used to realize the computer 302. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive, or a hybrid drive and/or a removable storage drive 414, which may include a magnetic tape drive, an optical disk drive, a solid state storage drive (such as a USB flash drive, a flash memory device, a solid state drive, or a memory card), or the like. The removable storage drive 414 reads from and/or writes to a removable storage medium 444 in a well-known manner. The removable storage medium 444 may include magnetic tape, optical disk, non-volatile memory storage medium, or the like, which is read by and written to by removable storage drive 414. As will be appreciated by persons skilled in the relevant art(s), the removable storage medium 444 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 440. Examples of a removable storage unit 422 and interface 440 include a program cartridge and cartridge interface (such as that found in video game console devices), a removable memory chip (such as an EPROM or PROM) and associated socket, a removable solid state storage drive (such as a USB flash drive, a flash memory device, a solid state drive, or a memory card), and other removable storage units 422 and interfaces 440 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the disclosure, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port (such as a serial, parallel, printer, GPIB, IEEE 1393, RJ35, and USB), an antenna with associated circuitry, and the like. The communication interface 424 may be wired or may be wireless. Software and data transferred via the communication interface 424 are in the form of signals which can be electronic, electromagnetic, optical, or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage medium 444, removable storage unit 422, a hard disk installed in storage drive 412, or a carrier wave carrying software over communication path 426 (wireless link or cable) to communication interface 424. Computer readable storage media refers to any non-transitory, non-volatile tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive, or a memory card), a hybrid drive, a magneto-optical disk, or a computer readable card, such as a SD card and the like, whether or not such devices are internal or external of the computing device 400. Examples of transitory or non-tangible computer readable transmission media that may also participate in the provision of software, application programs, instructions, and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the storage drive 412, or the interface 440. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments, one or more features of the computing device 400 may be omitted. Also, in some embodiments, one or more features of the computing device 400 may be combined together. Additionally, in some embodiments, one or more features of the computing device 400 may be split into one or more component parts.

1. A method for determining exceptions in a risk-mitigation schedule of an at-risk entity, the method comprising:
determining a plurality of parameters defining the at-risk entity, each parameter having a value and a value-type, wherein the value-type and value of at least one parameter from the plurality of parameters is derived from financial transaction data of the at-risk entity;
identifying, using a processor, a constraint for each parameter, each constraint being either a range including the value of the respective parameter, or a Boolean variable representing the value of the respective parameter;
using a schedule generator to:
generate an entity profile using the constraints;
determine, from at least one precedent profile stored in a memory device, a best fit precedent profile based on a minimum deviation of the best fit precedent profile from the entity profile, each of the at least one precedent profiles being generated based on a plurality of parameters defining at least one further entity that is different from the at-risk entity;
produce a precedent risk-mitigation schedule for the best fit precedent profile; and
determine at least one disparity between the precedent risk-mitigation schedule and the risk-mitigation schedule of the at-risk entity; and
displaying, on a display, an exceptions schedule to the at-risk entity, the exceptions schedule comprising the at least one disparity.

2. The method according to claim 1, wherein determining the plurality of parameters comprises receiving payment scheme data from a payment scheme.

3. The method according to claim 2, wherein receiving financial data comprises receiving data regarding products or services procured by the first plurality of at-risk entities.

4. The method according to claim 1, wherein determining the plurality of parameters comprises receiving issuer-held data from an issuer bank from which at least one of the plurality of parameters may be determined.

5. The method according to claim 4, wherein receiving data from the issuer bank comprises receiving issuer-held data regarding a demographic of the at-risk entity.

6. The method according to claim 4, wherein receiving data from the issuer bank comprises receiving data regarding products or services procured by the at-risk entity.

7. The method according to claim 1, wherein determining the plurality of parameters comprises receiving insurer data from an insurer from which at least one of the plurality of parameters may be determined.

8. The method according to claim 5, wherein receiving data from the insurer bank comprises receiving one or both of the risk-mitigation schedule of the at-risk entity and at least one parameter of the at-risk entity.

9. The method according to claim 1, further comprising associating the at-risk entity with a customer segment according to at least one parameter from the plurality of parameters, the customer segment defining characteristics typical of at-risk entities with a comparable value for said at least one parameter.

10. The method according to claim 7, wherein determining the plurality of parameters comprises receiving customer segment data from a research business from which at least one of the plurality of parameters can be determined, the data relating to products and services commonly acquired by the customer segment.

11. The method according to claim 1, wherein determining a best fit precedent profile based on a minimum deviation from the entity profile comprises comparing one or more constraints common to each precedent profile with a corresponding one or more constraints used to generate the entity profile.

12. The method according to claim 9, wherein comparing one or more constraints comprises weighting the one or more constraints so that a deviation in one of two said constraints, between a precedent profile and the entity profile, has a greater influence on a deviation of the precedent profile from the entity profile than the other of the two constraints.

13. The method according to claim, wherein producing a precedent risk-mitigation schedule, when the best fit precedent profile is based on a plurality of parameters defining a single further entity, comprises obtaining a risk-mitigation schedule for the further entity and using the risk-mitigation schedule for the further entity as the precedent risk-mitigation schedule.

14. The method according to claim, wherein producing a precedent risk-mitigation schedule, when the best fit precedent profile is based on a plurality of parameters defining two or more further entities, comprises obtaining a risk-mitigation schedule for each further entity and averaging the risk-mitigation schedules for those entities.

15. The method according to claim 14, wherein averaging the risk-mitigation schedules of the further entities comprises weighting at least one constraint and applying a corresponding weighting to the risk-mitigation schedules for each entity based on an inverse of a deviation of a corresponding constraint of an entity profile for each further entity from each weighted constraint.

16. The method according to claim 1, wherein determining at least one disparity between the precedent risk-mitigation schedule and the risk-mitigation schedule of the at-risk entity comprises identifying at least one difference between a constraint of the precedent risk-mitigation schedule and a corresponding constraint of the risk-mitigation schedule of the at-risk entity.

17. The method according to claim 1,
further comprising applying one or more adjustments to the exceptions schedule, the one or more adjustments being to perform at least one of:
adding a disparity to the exceptions schedule;
removing a disparity from the exceptions schedule; and
adjusting a disparity in the exceptions schedule.

18. A computer system for determining exceptions in a risk-mitigation schedule of an at-risk entity, the system comprising:
a memory device for storing data;
a display; and
a processor coupled to the memory device and being configured to:
determine a plurality of parameters defining the at-risk entity, each parameter having a value and a value-type, wherein the value-type and value of at least one parameter from the plurality of parameters is derived from financial transaction data of the at-risk entity;
identify a constraint for each parameter, each constraint being either a range including the value of the respective parameter, or a Boolean variable representing the value of the respective parameter; and
a schedule generator coupled to the processor and configured to:
generate an entity profile using the constraints;
determine, from at least one precedent profile stored in a memory device, a best fit precedent profile based on a minimum deviation of the best fit precedent profile from the entity profile, each of the at least one precedent profiles being generated based on a plurality of parameters defining at least one further entity that is different from the at-risk entity;
produce a precedent risk-mitigation schedule for the best fit precedent profile; and
determine at least one disparity between the precedent risk-mitigation schedule and the risk-mitigation schedule of the at-risk entity; and
the processor being further configured to displaying, on the display, an exceptions schedule to the at-risk entity, the exceptions schedule comprising the at least one disparity.

19. The system of claim 18, wherein the processor is configured to determine the plurality of parameters comprises receiving payment scheme data from a payment scheme.

20. The system of claim 19, wherein the processor is configured to receive financial data by receiving data regarding products or services procured by the first plurality of at-risk entities.

21. The system of claim 18, wherein the processor is configured to associate the at-risk entity with a customer segment according to at least one parameter from the plurality of parameters, the customer segment defining characteristics typical of at-risk entities with a comparable value for said at least one parameter.

22. The system of claim 21, wherein the processor is configured to determine a best fit precedent profile based on a minimum deviation from the entity profile by comparing one or more constraints common to each precedent profile with a corresponding one or more constraints used to generate the entity profile.

23. A computer program embodied on a non-transitory computer readable medium for generating a precedent risk-mitigation schedule for a customer segment, the program comprising at least one code segment executable by a computer to instruct the computer to:
determine a plurality of parameters defining the at-risk entity, each parameter having a value and a value-type, wherein the value-type and value of at least one parameter from the plurality of parameters is derived from financial transaction data of the at-risk entity;
identify, using a processor, a constraint for each parameter, each constraint being either a range including the value of the respective parameter, or a Boolean variable representing the value of the respective parameter;
generate an entity profile using the constraints;
determine, from at least one precedent profile stored in a memory device, a best fit precedent profile based on a minimum deviation of the best fit precedent profile from the entity profile, each of the at least one precedent profiles being generated based on a plurality of parameters defining at least one further entity that is different from the at-risk entity;
produce a precedent risk-mitigation schedule for the best fit precedent profile;
determine at least one disparity between the precedent risk-mitigation schedule and the risk-mitigation schedule of the at-risk entity; and
the processor being further configured to displaying, on the display, an exceptions schedule to the at-risk entity, the exceptions schedule comprising the at least one disparity.

24. The computer program of claim 23, wherein the at least one code segment is configured to instruct the computer to determine the plurality of parameters comprises receiving payment scheme data from a payment scheme.

25. The computer program of claim 24, wherein the at least one code segment is configured to instruct the computer to receive financial data by receiving data regarding products or services procured by the first plurality of at-risk entities.

26. The computer program of claim 23, wherein the at least one code segment is configured to instruct the computer to associate the at-risk entity with a customer segment according to at least one parameter from the plurality of parameters, the customer segment defining characteristics typical of at-risk entities with a comparable value for said at least one parameter.

27. The computer program of claim 26, wherein the at least one code segment is configured to instruct the computer to determine a best fit precedent profile based on a minimum deviation from the entity profile by comparing one or more constraints common to each precedent profile with a corresponding one or more constraints used to generate the entity profile.
